(19) United States
(12) Patent Application Publication
(10) Pub. No.: US 2016/0183187 A1
(43) Pub. Date: Jun. 23, 2016

(54) ADJACENT CHANNEL INTERFERENCE MITIGATION FOR LOW-POWER WAKE-UP RADIO

(71) Applicant: Intel Corporation, Santa Clara, CA (US)

(72) Inventor: Minyoung Park, Portland, OR (US)

(21) Appl. No.: 14/579,716

(22) Filed: Dec. 22, 2014

(51) Int. Cl. H04W 52/02; H04W 72/08

(52) U.S. Cl. CPC H04W 52/0225; H04W 72/082

(57) ABSTRACT

This disclosure describes systems, methods, and computer-readable media related to adjacent channel interference mitigation. A first computing device may detect a first wireless channel allocated for transmission of one or more data packets from the first computing device to a second computing device. The first computing device made detect a second wireless channel. The first computing device may determine a workload level of the second wireless channel. The first computing device may send a wake-up data packet to the second computing device based at least in part on the workload level.

### TECHNICAL FIELD

This disclosure generally relates to systems and methods for wireless communications and, more particularly, to adjacent channel interference mitigation.

### BACKGROUND

Advances in wireless communications require the efficient use of battery power to allow users to utilize their devices for longer times between recharges or replacement. For example, small computing devices such as wearable devices and sensors are constrained by their small battery capacity, but still need to support wireless communications technologies such as Wi-Fi or Bluetooth to connect to other computing devices (e.g., smartphones). To maximize battery life, it is desirable for computing devices to operate in the most efficient manner, conserving energy wherever possible.

### BRIEF DESCRIPTION OF THE FIGURES

Reference will now be made to the accompanying drawings, which are not necessarily drawn to scale, and wherein:

FIG. 1 is a schematic diagram illustrating data flow between components of an adjacent channel interference mitigation system, in accordance with one or more embodiments of the disclosure.

FIG. 2 is a schematic block diagram illustrating an example architecture of a computing device configured for adjacent channel interference mitigation, in accordance with example embodiments of the disclosure.

FIG. 3 is an illustrative data flow between components of a wireless communication session that does not operate in accordance with embodiments.

FIG. 4 is an illustrative data flow between components of an illustrative adjacent channel interference mitigation system in wireless communications accordance with one or more embodiments of the disclosure.

FIG. 5 is a flow diagram of an illustrative process for adjacent channel interference mitigation in accordance with one or more embodiments of the disclosure.

FIG. 6 is a flow diagram of an illustrative process for adjacent channel interference mitigation in accordance with one or more embodiments of the disclosure.

### DETAILED DESCRIPTION OF EMBODIMENTS OF THE DISCLOSURE

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the invention to those skilled in the art. Like numbers refer to like, but not necessarily the same or identical, elements throughout.

The terms “communication station”, “station”, “handheld device”, “mobile device”, “wireless device” and “user equipment” (UE), as used herein, refer to a wireless communication device such as a cellular telephone, smartphone, tablet, netbook, wireless terminal, laptop computer, a wearable computer device, a femtocell, High Data Rate (HDR) subscriber station, access point, access terminal, or other personal communication system (PCS) device. The device may be either mobile or stationary.

The term “access point” (AP) as used herein may be a fixed station. An access point may also be referred to as an access node, a base station or some other similar terminology known in the art. An access terminal may also be called a mobile station, a user equipment (UE), a wireless communication device or some other similar terminology known in the art. Embodiments disclosed herein generally pertain to wireless networks. Some embodiments can relate to wireless networks that operate in accordance with one of the IEEE 802.11 standards including the IEEE 802.11ax standard. Other embodiments can relate to determination of communication status. Further, certain embodiments can relate to channel reservation during communication status determination.

Numerous techniques exist for minimizing computing device energy consumption, such as by powering off one or more communications blocks (e.g., radio system(s)) while maintaining data transmission and reception so as not to increase latency. For instance, a computing device may power off the one or more communications blocks until there are data packets to transmit or just before receiving data packets.

Low energy consumption also may be achieved by adding a low-power wake-up receiver to one or more computing devices to wake-up the main radio system when data is available to be transmitted and/or received. The low-power wake-up receiver integrated in the circuitry of a computing device and may be configured to receive and send a wake-up message as an indication that the radio system of the computing device needs to be powered on in order to start receiving/sending data.

However, low-power wake-up receivers are designed to operate at particularly low power levels, and are often of relatively simple design and built with low precision parts. This may, unfortunately, render the low-power wake-up receiver susceptible to adjacent channel interference (ACI). Accordingly, when a wake-up packet that overlaps with an ACI, the wake-up packet may be incorrectly received and/or decoded at the receiving computing device, which may necessitate a retransmission of the wake-up packet by the transmitting computing device. This may lead to undesirable power consumption at the transmitting computing device side.

In some embodiments, a transmitting computing device may determine whether ACI is present in adjacent channels before transmitting the wake-up packet to the receiving computing device. Accordingly, if ACI is determined to be present and strong (e.g., signal strength greater than a threshold), then the transmitting computing device may delay the transmission of the wake-up packet until the ACI is determined to be sufficiently low or non-existent.

The wake-up packet may be delayed in order to prevent interference with or corruption due to the ACI that might result in incorrect decoding of the wake-up packet at the receiving computing device side. For example, ACI may alter the wake-up packet by combining with its signal(s) and/or introducing noise in the wake-up packet. The result of the ACI interference may be a distorted wake-up packet that may not be correctly recognized and/or decoded by a receiving computing device. Delaying the transmission of the wake-up packet may also prevent the need to retransmit the wake-up packet if there is corruption or interference with the ACI. Retransmitting the wake-up packet may result in additional power consumption by the transmitting computing device. For example, a transmitting computing device 102 may determine the presence of ACI in adjacent channel(s) before transmitting a wake-up packet to a receiving computing device 104.

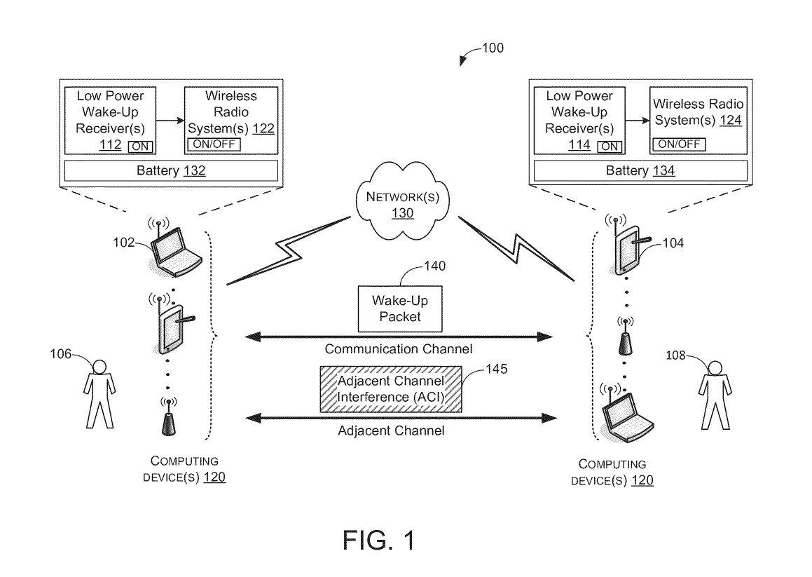

FIG. 1 depicts an illustrative schematic diagram of a channel interference mitigation system 100 in accordance with one or more embodiments of the disclosure.

The computing device(s) 120 (e.g., computing devices 102 and 104) may include any suitable processor-driven computing device including, but not limited to, a desktop computing device, a laptop computing device, a server, a router, a switch, an access point, a smartphone, a tablet, wearable wireless device (e.g., bracelet, watch, glasses, ring, etc.) and so forth. The computing device(s) 120 may be mobile devices that are non-stationary or may be stationary devices, such as a base station, an access point, which may have a fixed location. Any of the computing devices 120 (e.g., computing devices 102 and/or 104) may be configured to communicate with each other and any other component of the system 100 via one or more communications networks 130. Any of the communications networks 130 may include, but are not limited to, any one or a combination of different types of suitable networks such as, for example, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

Any of the computing devices 120 may include one or more communications antenna. Communications antenna may be any suitable type of antenna corresponding to the communications protocols used by the computing devices 102, 104. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the computing devices 102, 104.

Any of the computing devices 120 may include any suitable radio and/or transceiver for transmitting and/or receiving radio frequency (RF) signals in the bandwidth and/or channels corresponding to the communications protocols utilized by any of the computing devices 102, 104 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

The computing device 102 may include low-power wake-up receiver(s) 112, wireless radio system(s) 122, and battery 132. Computing device 104 may include low-power wake-up receiver(s) 114, wireless radio system(s) 124, and battery 134. The low-power wake-up receiver(s) 112, 114 may include circuitry that may be comprised of one or more hardware components that may be configured to detect a wake-up packet received over communication network 130 from another computing device. In one embodiment, the low-power wake-up receiver(s) 112, 114 may use simple modulation schemes such as on-off keying (OOK), amplitude shift keying (ASK) or frequency shift keying (FSK) for transmitting and receiving data. The low-power wake-up receiver(s) 112, 114 may use low precision components, which may make it more susceptible to channel interferences (e.g., ACI 145) coming from adjacent channels. The wireless radio system(s) 122, 124 may include one or more hardware components, such as one of transmitters, receivers and/or transceivers able to send and/or receive wireless communication signals, RF signals, frames, blogs, transmission streams, packets, messages, data items, and/or data.

In some example embodiments, the computing device 102 may transmit a wake-up packet 140 to the computing device 104. Upon receiving the wake-up packet 140, the low-power wake-up receiver 114 of the computing device 104 may detect and/or decode the wake-up packet 140, and may determine whether the wake-up packet 140 is intended for it. However if there is interference (e.g., ACI) from adjacent channels, then the wake-up packet 140 may be either corrupted or not properly decoded at the computing device 104. If the computing device 104 determines that the wake-up packet is not corrupted due to ACI, the computing device 104 may determine that the address field in the MAC header of the wake-up packet matches the address of the computing device 104, then the low-power wake-up receiver 114 may send a signal to the wireless radio system 124 to power on its circuitry containing one or more hardware components.

In response to detecting the wake-up packet, the low-power wake-up receiver(s) 112, 114 may determine whether to wake-up the wireless radio system(s) 122, 124. The wake-up packet (e.g., a wake-up packet 140) may indicate to the low-power wake-up receiver(s) 112, 114 that the corresponding wireless radio system(s) 122, 124 should power on (or wake-up) in order to send or receive data. The wireless radio system(s) 122, 124 may stay powered on during a communication session at least as long as there is data to be transmitted and/or received. However, if the wake-up packet was not properly decoded due to ACI, the computing device 102 may re-transmit the wake-up packet intended for the computing device 104. At the completion of the communication session, the computing device 104 may power off some or all of its circuitry, such as the wireless radio system(s) 122, 124, to reduce power consumption and preserve the life of the battery 132, 134, after receiving and/or transmitting the data during the wake-up period. In one embodiment, the wireless radio system(s) 122, 124 may stay powered on during an active communication session with another computing device. The wireless radio system(s) 122, 124 may stay powered off when there is no active communication with another computing device. This may allow for power savings since the wireless radio system(s) 122, 124 powers on when there is an active session, and powers off when there are no active sessions. In contrast, the low-power wake-up receiver(s) 112, 114 may be constantly active (e.g., powered on). This may be possible, in part, because the low-power wake-up receiver 112, 114 may have a relatively low power consumption compared to the wireless radio system(s) 122, 124. The computing device 104 may respond to the computing device 102 with an indication, such as a clear to send (CTS) frame, that the wake-up packet was received correctly and the computing device 104 wireless radio system 124 is ready to receive data packet(s) from the computing device 102. If the CTS frame is not received by the computing device 102, for example, after a timeout timer expires, the computing device 102 may retransmit a wake-up packet 140.

In one embodiment, a transmitting computing device 102 may attempt to detect ACI on an adjacent channel before transmitting a packet because the ACI may distort the decoding of the packet by the recipient. If identified, then the computing device 102 may delay sending a wake-up packet 140 to the computing device 104. Specifically, detection of ACI 145 of adjacent channel(s) may be used to determine if ACI 145 will interfere with a communication session between two computing devices 120, such as based on the strength of the ACI signal. This is especially important when some of the hardware components on the computing devices are more susceptible to interferences from adjacent channels because of trade-offs between cost and efficiency.

The battery(s) 132, 134 may be any device that may contain one or more cells in which chemical energy is converted into electricity and used as a source of power. For example, the battery 132, 134 may be used during the operation of the computing device 120. Each of the battery(s) 132, 134 may have a determined charge holding capacity and performance statistics that may be associated with the physical size of the battery(s) 132, 134. Since the computing device 120 may be small, such as a wearable device, conserving the power of the battery(s) 132, 134 may be necessary in order to prolong the operation of the computing device 120.

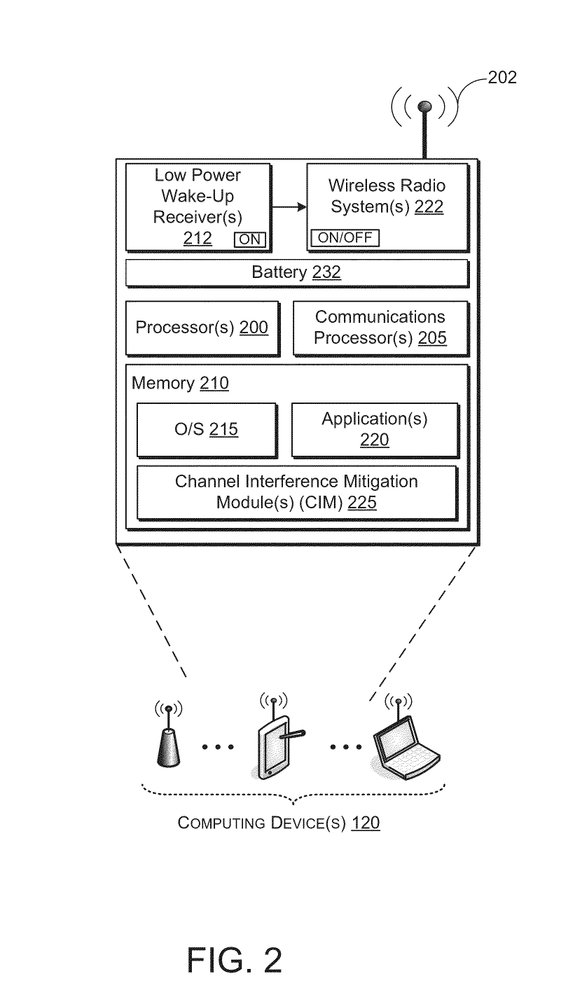

Referring now to FIG. 2, a block diagram illustrating elements of the example computing device(s) 120 that may communicate via network(s) 130 in accordance with illustrative embodiments of the disclosure is discussed.

The computing device(s) 120 may include processor(s) 200, communications processor(s) 205, antenna(s) 202, memory(s) 210, wireless radio system(s) 222 low power wake-up receiver(s) 212, and/or battery(s) 232.

As depicted herein, the processor(s) 200 may be configured to operate instructions, applications, and/or software associated with services provided by the computing devices 102 and 104. These instructions, applications, and/or software may be stored on the memory 210, depicted as operating system(s) (O/S) 215 and/or application(s) 220, and may be retrievable and executable by the processor(s) 200. Alternatively, the instructions, applications, and/or software executed by the processor(s) 200 may be stored in any suitable location, such as the cloud or other remote locations. The instructions, applications, and/or software modules, such as O/S 215 and/or application(s) 220 may or may not correspond to physical locations and/or addresses in the memory 210. In other words, the contents of each of the modules may not be segregated from each other and may be, in fact, stored in at least partially interleaved positions on the memory 210.

The processor(s) 200 may include, without limitation, a central processing unit (CPU), a digital signal processor (DSP), a reduced instruction set computer (RISC), a complex instruction set computer (CISC), or any combination thereof. The computing devices 102 and 104 may also include a chipset (not shown) for controlling communications between the processor(s) 200 and one or more of the other components of the computing devices 102 and 104. In one embodiment, the computing device(s) 120 may be based on an Intel® Architecture system, and the processor(s) 200 and the chipset may be from a family of Intel® processors and chipsets, such as the Intel® Atom® processor family. The processor(s) 200 may also include one or more processors as part of one or more application-specific integrated circuits (ASICs) or application-specific standard products (ASSPs) for handling specific data processing functions or tasks.

The antenna(s) 202 may be any suitable antenna for wireless communications. The antennas 202 may be directional or omni-directional. In certain embodiments, the antenna may be a patch antenna. In some cases, the antenna 202 may be integrated with one of the communications processor(s) 205, the processor(s) 200, or any other elements of the computing device(s) 120.

The communications processor(s) 205 may be configured to communicate with the processor(s) 200 or other elements of the computing device(s) 120 to transmit and/or receive communications signals, such as from the server device 104 via any suitable communications mechanism, link, channel, or standard. The communications processor 205 may be configured to receive a communications signal and appropriately modulate, or otherwise transform the signal and provide the signal to the antenna 202 for transmission via wireless channels, such as Wi-Fi. The communications processor(s) 205 may further be configured to receive communications signals from the antenna 202 and demodulate, or otherwise transform, the received signals, and provide the transformed signals to the processor(s) 200 for further processing and/or storage. In certain aspects, the communications processor(s) 205 may enable communications using a variety of modulation schemes, standards, and channels. In some cases, the communications processor(s) 205 may be a separate element from the processor(s) 200 and, in other cases, the communications processor(s) 205 may be integrated with the processor(s) 200.

The memory 210 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 210 may include an operating system (“O/S”) 215, applications 220, and channel interference mitigation module (“CIM”) 255.

The O/S 215 may be configured to enable the operation of the application(s) 220 on the processor(s) 200. In one aspect, the O/S 215 may provide a common interface for the application 220 to interface with, utilize, and/or control the various hardware elements of the computing device 120. The details of operating systems are well known and will not be discussed in significant detail herein. Example operating systems may include, but are not limited to, Google® Android®, Apple® iOS®, Microsoft® Windows Mobile®, Microsoft® Windows 7®, or the like. In certain aspects, such as in the context of providing sharing capability across computing devices 120, such as via a network, the O/S 215 may provide functionality and enable the sharing of capability. In certain embodiments, the O/S 215 may provide capability-sharing services to the application 220.

The CIM 225 may be configured to send and receive data on a communication channel that may be established between, for example, computing device 102 and computing device 104. In order for computing device(s) 102, 104 to communicate, a communication channel is first established between them. For example, an access point may operate as a master station that may facilitate that communication by allocating the communication channel. The CIM 225 may detect the allocated communication channel and determine whether it is permitted to transmit its packet. For example, a transmitting computing device 102 and a receiving computing device 104 may have established a communication channel (e.g., operating channel) that may be used to send and receive data between the transmitting computing device and receiving computing device. If computing device 102 is not permitted to transmit its data, it may have to wait until an available timeslot is detected following one or more communications standards criteria in order to prevent unnecessary data collisions on the operating channel. It is understood that the communication session and the data transmission between the computing devices 102 and 104 may comply with various communications standards, such as IEEE 802.11, including its various versions (e.g. IEEE 802.11 a/g or 802.11n, 802.11ac, 802.11ax, etc.).

In one embodiment, CIM 225 may detect whether adjacent channels are transmitting data and/or whether the adjacent channels may interfere with the operating channel of the transmitting computing device and receiving computing device. For example, although at least two computing devices 102, 104 may be communicating on an established communication channel, other computing devices 120 may also have established communication channels. CIM 225 may look for potential interferences coming from these adjacent channels.

In one embodiment, CIM 225 may receive an indication of a workload level of the adjacent channel(s). The workload level may be indicative of interference, e.g., ACI that may be generated from the adjacent channel(s). The workload level may be represented in the form of an energy level emanating from the adjacent channel(s). For example, if the adjacent channel(s) is not idle (e.g., transmitting data), the adjacent channel(s) may be emanating an energy level. In one embodiment, the CIM 225 may determine whether the energy level from the adjacent channel(s) exceeds the tolerance level of the components of the circuitry sensitivity of low-power wake-up receiver(s) 112, 114. The tolerance level may depend on the design of the low-power wake-up receiver 112, 114 circuitry containing one or more components. Low cost circuitry may be more susceptible to interferences from adjacent channels because of trade-offs between cost and efficiency. It is understood that the low-power wake-up receiver 112, 114 may be based on less expensive hardware components. In doing so, the low-power wake-up receiver(s) may have a relatively low tolerance to interferences generated from adjacent channels. Hence, the interference generated from adjacent channel(s) may indeed affect data transmissions to and from the computing devices 102 and 104.

In one embodiment, CIM 225 determine whether the energy level generated from adjacent channels may or may not interfere with the wake-up packet between the computing device 102 and the computing device 104. If the CIM 225 determines that the interference from the adjacent channels falls outside the tolerance level in such a way that it may interfere with the wake-up packet (e.g., wake-up packet), the CIM 225 may send the wake-up packet (e.g., data packet or a signal burst) to computing device 104. Upon successful transmission of the wake-up packet, the CIM 225 may wait to receive an indication that the computing device 104 has correctly received the wake-up packet. The indication may be in the form of a data packet, a signal burst, a clear to send (CTS) frame or any other type of indication. Upon successful reception of the indication, the CIM 225 may wait for its turn to transmit data on the communication channel before starting to transmit the data that is intended for the computing device 104.

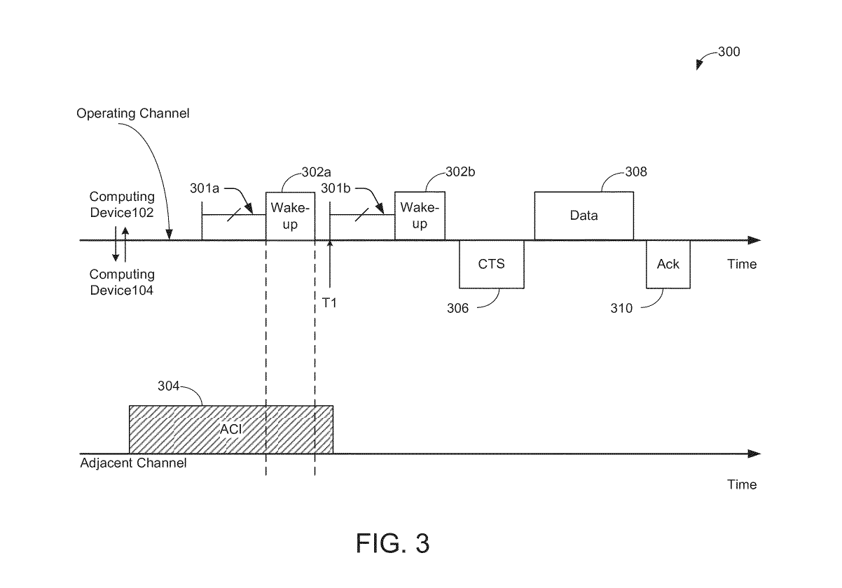

FIG. 3 is an illustrative data flow between two computing devices 102, 104 communicating on an operating channel in the proximity of an adjacent channel without detection of ACI.

In this example, a transmitting computing device 102 may send a wake-up packet without detecting interferences (e.g., ACI) from adjacent channel(s). If the wake-up packet is transmitted when there is an overlapping ACI, the wake-up packet may be incorrectly received at computing device 104 and/or decoded at the receiving computing device, which may cause a retransmission of the wake-up packet by the transmitting computing device. This may lead to undesirable power consumption at the transmitting computing device side.

The low-power wake-up receiver 112, 114 of both computing devices 102 and 104 may be activated (powered on) in order to listen for one or more wake-up packets. For example, if the transmitting computing device 102 sends a wake-up packet to the receiving computing device 104, the wake-up packet may cause the wireless radio system 124 of computing device 104 to power on in order to start the communicating with the transmitting computing device 102.

However, before sending any packets, a transmitting computing device (e.g., 102) may detect whether it can transmit on the operating channel. If the operating channel is available and the computing device 102 is permitted to transmit, the computing device 102 may transmit a wake-up packet 302 to wake up the computing device 104 after a channel access delay 301a. The channel access delay 301a may, in some embodiments, correspond to an interval of time between the issuance of two frames during a communication session between a transmitting computing device 120 (e.g., computing device 102) and a receiving computing device 120 (e.g., computing device 104). The channel access delay 301a may include various durations; for example, inter space frames (IFS) that corresponds to an interval of time between the issuance of two frames. It is understood that IFS may have various types of intervals according to the various wireless standards. For example, according to the IEEE 802.11 standards, IFS may have three types: 1) short IFS (SIFS), which is the minimum time between the last symbol of a frame and the beginning of the first symbol of the next frame; 2) distributed coordination function IFS (DIFS), which may be used when a station wants to initiate a communication; and 3) point coordination function IFS (PIFS), which may be used by an access point (AP) to perform polling. The channel access delay 301a may be set automatically by the system or may be set by the administrator or by a user on the system. It is understood that the channel access delay 301a may follow communications standards, such as IEEE 802.11 standards and its various provisions (e.g. IEEE 802.11 a/g or 802.11n, etc.).

Typically, if the computing device 102 determines that the operating channel is busy with a current transmission, the computing device 102 may not transmit until the end of the current transmission and then may wait an additional duration (e.g., SIFS, PIFS, and/or DIFS), and generates a random backoff timer. The backoff timer is decreased as long as the medium is sensed to be idle for a duration (e.g., SIFS, PIFS, and/or DIFS), paused when a transmission is detected on the medium, and resumed when the channel is detected as idle again for the duration (e.g., SIFS, PIFS, and/or DIFS). When the backoff timer reaches zero, the computing device 102 may transmit its packets. This technique is meant to alleviate collisions on an operation channel,

Once the computing device 102 determines that the operating channel is continuously idle for a duration (e.g., SIFS, PIFS, and DIFS), the computing device 102 may transmit a frame to the computing device 104. As illustrated in FIG. 3, a wake-up packet 302 is sent without consideration of adjacent inferences. However, one or more adjacent channels may be busy, and hence may generate an ACI (e.g., ACI 304) that may overlap with the transmission of the wake-up packet 302. Consequently, the wake-up packet 302 may not be received correctly by the computing device 104 because the ACI 304 may interfere with the wake-up packet 302 received by the computing device 104. The ACI 304 interferes with wake-up 302 because of the low-power wake-up receiver 112, 114 tolerance to interferences. As a result, the computing device 104 may not recognize the wake-up packet (e.g., wake-up packet 302) coming from the computing device 102. Consequently, the computing device 104 may not respond to the wake-up packet 302 wake-up packet. The computing device 102 may wait to receive an indication from computing device 104 that the wake-up packet 302 was received. The computing device 120 may wait for a duration of time T1 before determining that the wake-up packet 302 was not received by computing device 104. After the duration of time T1, the computing device 102 may repeat the cycle of checking the availability of the operating channel before preparing to resend the wake-up packet 302. For instance, the computing device 102 may wait for a duration of channel access delay 301b, and may retransmit the wake-up packet 302b. At the time, if the adjacent channel has little to no interferences, the wake-up packet 302b may be correctly received and decoded by the computing device 104. However, such mechanism may result in expenditure of additional power from the transmitting computing device 102 resulting in quicker depletion of the battery 132, 134132, 134.

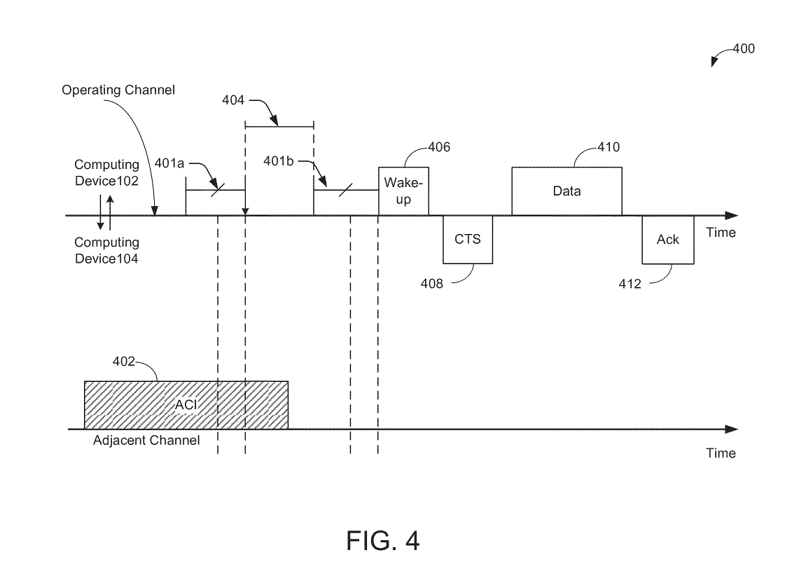

FIG. 4 is an illustrative data flow between components of an illustrative channel interference mitigation system in wireless communications accordance with one or more embodiments of the disclosure.

In this example, if the transmitting computing device 102 has one or more data packets to transmit to a receiving computing device 104, the transmitting computing device 102 may first detect the operating channel allocated for such transmission. The transmitting computing device 102 may first determine whether the operating channel is idle for certain duration before it may be allowed to start transmitting its data to the receiving computing device 104.

Once the transmitting computing device 102 determines that the operating channel is idle during the required duration of the channel access delay 401a, the transmitting computing device 102 may detect a workload level of adjacent channel(s). The workload level may be an energy level emanating from the adjacent channel(s). The transmitting computing device 102 may determine whether one or more adjacent channels are generating energy levels that may interfere with the transmitting computing device's own data transmission (e.g., wake-up packet).

In one embodiment, if the operating channel is idle but one or more adjacent channels are sensed as busy due to an energy detected in the adjacent channel that may be higher than what the low-power wake-up receiver can tolerate, the transmitting computing device may defer the transmission of the wake-up packet until a later time (e.g., 404). The time deferred (e.g., 404) may be a time duration sufficient to determine that one or more adjacent channels is no longer generating an energy level that may cause interference. For example, if the adjacent channel becomes idle after the time duration 404, the energy level generated may fall below the tolerance threshold of the low-power wake-up receiver and it may be determined by the transmitting computing device that there is no interference coming from adjacent channels. In that case, the transmitting computing device 102 may wait for a period equivalent to the channel access delay 401b. After passage of 401b, the transmitting computing device 102 may determine whether there are any overlapping interferences from adjacent channels and if not, it may transmit the wake-up packet 406. In other words, the transmitting computing device 102 may continue to wait for a deferred time 404 and for the channel access delay before transmitting the wake-up packet 406. This may prevent retransmissions due to the existence of an ACI 402 from adjacent channels that may interfere with the wake-up packet 406. This may also result in power conservation at the transmitting computing device 102 for preventing a retransmit of a wake-up packet. Furthermore, lower design constraints may be used for the design of the low-power wake-up receiver 112, 114 resulting in even lower power consumption.

In one embodiment, an energy detection threshold may be adjusted based on the performance of the low-power wake-up receiver 112, 114. For example, if the receiving computing device (e.g., computing device 104) can tolerate more interference in the adjacent channel, the energy detection threshold may be adjusted to a higher value. If the operating channel is idle for at least the channel access delay 401a and the adjacent channel is sensed as idle (e.g. if the energy detected in the adjacent channel is lower than what the low-power wake-up receiver of the receiving computing device can tolerate), the computing device 102 may transmit the wake-up packet 406 to the computing device 104 on the operating channel. The computing device 102 may then wait for a response frame (e.g. CTS 408) from the computing device 104. For example, upon successful reception and decoding of the wake-up packet 406, the computing device 104 may send a CTS 408, to acknowledge that the packet has been received. In one embodiment, upon receiving a response frame (e.g., CTS) from the computing device 104, the computing device 102 may transmit a data frame (e.g., data frame 410) and may wait for an acknowledgement frame (e.g. Ack frame 412).

In one embodiment, upon receiving the wake-up packet 406, the low-power wake-up receiver 114 of the receiving computing device 104 may send a signal to wake-up its wireless radio system(s) 124. Upon receiving the signal, the wireless radio system(s) 124 may power on its components in order to start handling the data communication (e.g., receive and send data packets) between the computing device 102 and the computing device 104. The computing device 104 may then respond to the computing device to indicate that the wake-up packet 406 has been received and correctly decoded. For example, the computing device 104 may send CTS 408 to the computing device 102. The computing device 104 may wait for the computing device 102 to start transmitting its data packets (e.g., data packet 410). Upon receiving the data packet 410 correctly, the computing device 104 may respond with an acknowledgment (e.g., Ack 412). Afterwards, when there is no more data packets that need to be exchanged between the two devices (e.g., computing devices 102 and 104), the low-power wake-up receiver 112, 114 may power off the wireless radio system(s) 122, 124 for the computing devices 102 and 104.

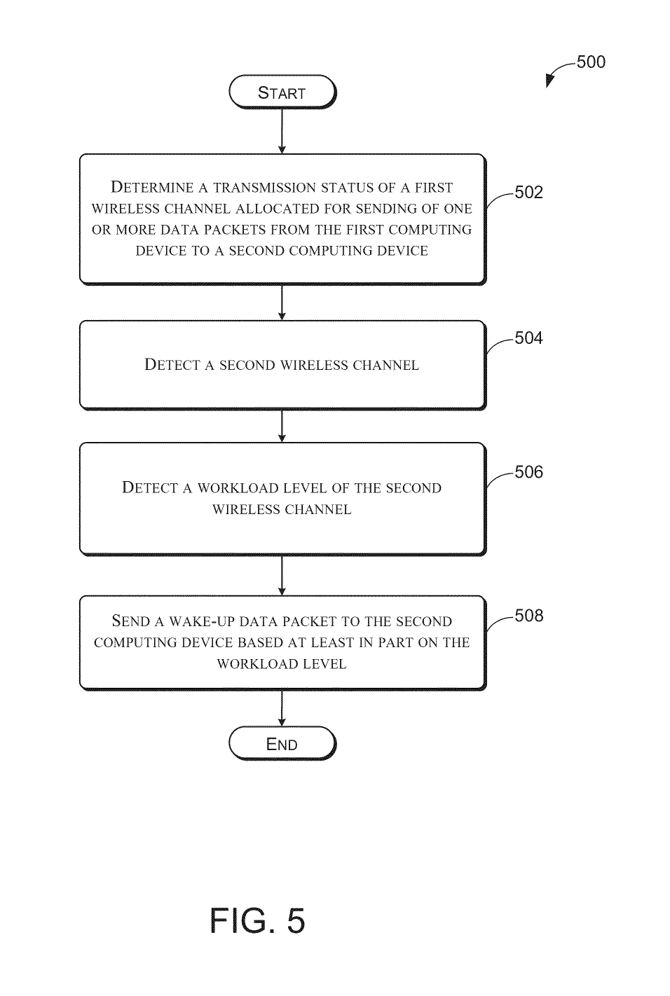

FIG. 5 illustrates a flow diagram of illustrative process 500 for an adjacent channel interference mitigation system in accordance with one or more embodiments of the disclosure. At block 502, the CIM 225 may detect the operating channel (e.g., IEEE 802.11 channel #1) using its wireless radio system(s) 122, 124. For example, when a channel is established between the computing device 102 and the computing device 104, the channel may be monitored by either one of the computing devices 102 and 104 in order to determine when and when not to transmit data.

At block 504, the CIM 225 may also detect neighboring channels in order to determine whether there is any interference that may affect the transmission of data between the computing devices 102 and 104. An example of detection may be the detection of the energy level generated from adjacent channels. The energy level detected may result in interference with the data signals that the computing devices 102 and 104 may be transmitting. For example, if the adjacent channel(s) is not idle (e.g., transmitting data), the adjacent channel(s) may have an energy level that may fall outside the tolerance level of the components of the circuitry sensitivity of low-power wake-up receiver(s) 112, 114. The tolerance level may depend on the design of the low-power wake-up receiver circuitry containing one or more components circuitry. At block 506, the CIM 225 may determine whether the energy level generated from adjacent channels meet a certain criteria. The criteria may depend on the design of the low-power wake-up receiver circuitry containing one or more components. For example, various components may have a certain tolerance to energy levels generated from adjacent channels. Based on that tolerance, it may be determined whether an energy level may interference with data transmissions between two computing devices (e.g., computing device 102 and 104). For example if the operating channel is idle but the adjacent channel is sensed as busy (e.g., if the energy detected in the adjacent channel is higher than what the low-power wake-up receiver 112, 114 can tolerate, e.g., above −62 dBm), the transmitting computing device 102 may defer sending the wake-up packet. The energy detection threshold may be adjusted based on the performance of the low-power wake-up receiver 114 of the receiving computing device 104. For example, if computing device 104 can tolerate more interference coming from an adjacent channel, the energy detection threshold may be adjusted to a higher value (e.g. −52 dBm).

At block 508, the CIM 225 may send a wake-up packet (e.g., a data packet or a signal burst) to a receiving computing device 104 at a time when the energy level generated from adjacent channels may not interference with the wake-up packet. For example, If the transmitting computing device 102 determines that the operating channel is busy, the computing device 102 may delay its transmission until the end of the current transmission and then may wait an additional duration (e.g., SIFS, PIFS, and/or DIFS), and generates a random backoff timer. The backoff timer is decreased as long as the medium is sensed to be idle for a duration (e.g., SIFS, PIFS, and/or DIFS), paused when a transmission is detected on the medium, and resumed when the channel is detected as idle again for the duration (e.g., SIFS, PIFS, and/or DIFS). When the backoff timer reaches zero, the computing device 102 may transmit its packets. When the transmitting computing device 102 determines that the operating channel is continuously idle for a duration (e.g., SIFS, PIFS, and DIFS), the transmitting computing device 102 may transmit a frame to the computing device 104. If the transmitting computing device 102 determines that the operating channel is busy during that duration (e.g., SIFS, PIFS, and DIFS), the transmitting computing device 102 may defer its transmission of data packets on the operating channel.

The CIM 225 may wait to receive an indication that the receiving computing device has correctly received the wake-up packet (e.g., computing device 104). The indication may be in the form of a data packet, a signal burst a CTS frame or any other type of indication. Upon receiving the indication that the receiving computing device has correctly received the wake-up packet, the CIM 225 may start sending its data packets that are intended for the receiving computing device.

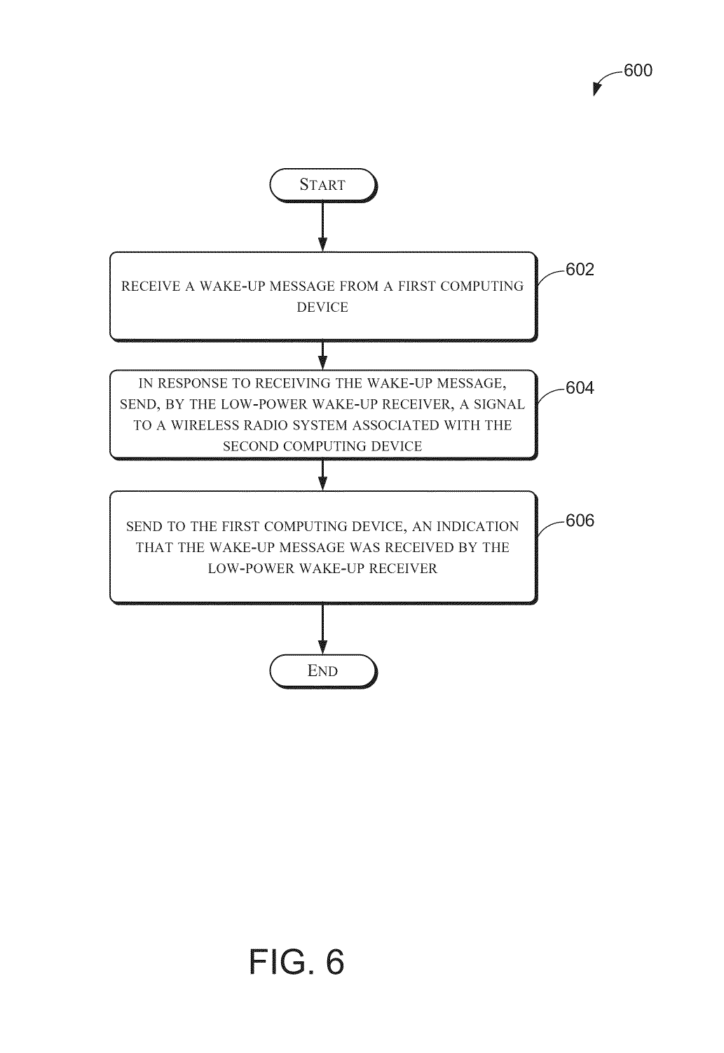

FIG. 6 illustrates a flow diagram of an illustrative process 600 for an adjacent channel interference mitigation system in accordance with one or more embodiments of the disclosure.

At block 602, the CIM 225 may receive a wake-up packet (e.g., wake-up packet) from a transmitting computing device (e.g., computing device 102). The CIM 225 may decode the wake-up packet and may determine whether the wake-up packet is intended for the receiving computing device (e.g., computing device 104). The CIM 225 may determine whether the wake-up packet is properly decoded. If the wake-up packet was not correctly decoded, the CIM 225 may ignore and/or discard the wake-up packet.

At block 604, the CIM 225 may send a signal to wake up the wireless radio system(s) 122, 124 if the CIM 225 determines that the receiving computing device (e.g., computing device 104) is the intended receiving computing device of the wake-up packet, and the wake-up packet was correctly decoded. The signal may cause the wireless radio system(s) 122, 124 to become active by powering on. Upon powering on, the wireless system(s) 122, 124 may be ready to send and receive communications signals and data.

At block 606, the CIM 225 may respond by sending an indication to the computing device 102 that the wake-up packet has been correctly received by the receiving computing device (e.g., computing device 104), that the wake-up packet was properly decoded and that the receiving computing device was the intended receiving computing device. The indication may be in the form of a data packet, a signal burst, a CTS frame or any other type of indication. The CIM 225 may respond by sending an acknowledgment to the transmitting computing device (e.g., computing device 102) that the user data received from the transmitting computing device (e.g., computing device 102).

In example embodiments of the disclosure, there may be a method for wireless communication. The method may include determining, by a first computing device comprising one or more processors and at least one radio component, a transmission status of a first wireless channel allocated for sending of one or more data packets from the first computing device to a second computing device. The method may include detecting, by the first computing device, a second wireless channel. The method may include detecting, by the first computing device, a workload level of the second wireless channel associated with an interference with the first wireless channel. The method may include sending, by the first computing device, a wake-up data packet to the second computing device based at least in part on the workload level. The method may further include determining, by the first computing device, an idle status of the second wireless channel. The interference may alter the wake-up packet into a distorted wake-up packet. Sending the wake-up data packet may be based at least in part on the idle status of the second wireless channel. The method may further include receiving, by the first computing device, a clear to send message from the second computing device in response to sending the wake-up packet. The workload level may be an energy level associated with one or more data transmissions on the second channel. Determining the transmission status may include determining if the first wireless channel is idle. The second wireless channel may be adjacent to the first wireless channel. Detecting the workload level may further include detecting a first workload that satisfies an interference threshold, and detecting, after a delay of at least a channel access delay duration a second workload level that does not satisfy the interference threshold. The channel access delay duration may include at least one of distributed coordination inter frame space (DIFS), point coordination inter frame space (PIFS), and short inter frame space (SIFS).

According to example embodiments of the disclosure, there may be a computing device. The computing device may include a transceiver configured to transmit and receive wireless signals, an antenna coupled to the transceiver, one or more processors in communication with the transceiver, at least one memory that stores computer-executable instructions, and at least one processor of the one or more processors configured to access the at least one memory. The at least one processor of the one or more processors may be configured to execute the computer-executable instructions to determine a transmission status of a first wireless channel allocated for sending of one or more data packets from the first computing device to a second computing device. The at least one processor may be configured, in response to execution of the instructions, to detect a second wireless channel. The at least one processor may be configured, in response to execution of the instructions, to detect a workload level of the second wireless channel. The at least one processor may be configured, in response to execution of the instructions, to send a wake-up data packet to the second computing device based at least in part on the workload level. The at least one processor may be further configured, in response to execution of the instructions, to determining, by the first computing device, an idle status of the second wireless channel. Sending the wake-up data packet may be based at least in part on the idle status of the second wireless channel. The at least one processor may be further configured, in response to execution of the instructions, to receiving, by the first computing device, a clear to send message from the second computing device in response to sending the wake-up packet. The workload level may be an energy level associated with one or more data transmissions on the second channel. Determining the transmission status may include determining if the first wireless channel is idle. Detecting the workload level may further include detecting a first workload that satisfies an interference threshold, and detecting, after a delay of at least a channel access delay duration a second workload level that does not satisfy the interference threshold.

In example embodiments of the disclosure, there may be a computer-readable medium storing computer-executable instructions which, when executed by a processor, cause the processor to perform operations. The operations may include determining a transmission status of a first wireless channel allocated for sending of one or more data packets from the first computing device to a second computing device. The operations may include detecting a second wireless channel. The operations may include detecting a workload level of the second wireless channel associated with an interference with the first wireless channel. The operations may include sending a wake-up data packet to the second computing device based at least in part on the workload level. The operations may further include determining, by the first computing device, an idle status of the second wireless channel. The interference may alter the wake-up packet into a distorted wake-up packet. Sending the wake-up data packet may be based at least in part on the idle status of the second wireless channel. Detecting the workload level may further include detecting a first workload that satisfies an interference threshold, and detecting, after a delay of at least a channel access delay duration a second workload level that does not satisfy the interference threshold. The channel access delay duration may include at least one of distributed coordination inter frame space (DIFS), point coordination inter frame space (PIFS), and short inter frame space (SIFS).

In example embodiments of the disclosure, there may be a wireless communication system. The system may include at least one memory that store computer-executable instructions, and at least one processor configured to access the at least one memory, wherein the at least one processor may be configured to execute the computer-executable instructions to detect, by the antenna, a first wireless channel allocated for transmission of one or more data packets to a second computing device. The at least one processor may be configured to execute the computer-executable instructions to determine a transmission status of a first wireless channel allocated for sending of one or more data packets from the first computing device to a second computing device. The at least one processor may be configured to execute the computer-executable instructions to detect a second wireless channel. The at least one processor may be configured to execute the computer-executable instructions to detect a workload level of the second wireless channel associated with an interference with the first wireless channel. The at least one processor may be configured to execute the computer-executable instructions to send a wake-up data packet to the second computing device based at least in part on the workload level. The at least one processor may be further configured to execute the computer-executable instructions to determine an idle status of the second wireless channel. The interference may alter the wake-up packet into a distorted wake-up packet. Sending the wake-up data packet may be based at least in part on the idle status of the second wireless channel. The at least one processor may be further configured to execute the computer-executable instructions to receive a clear to send message from the second computing device in response to sending the wake-up packet. The workload level may be an energy level associated with one or more data transmissions on the second channel. Determining the transmission status may include determining if the first wireless channel is idle. The second wireless channel may be adjacent to the first wireless channel. Detecting the workload level may further include detecting a first workload that satisfies an interference threshold, and detecting, after a delay of at least a channel access delay duration a second workload level that does not satisfy the interference threshold. The channel access delay duration may include at least one of distributed coordination inter frame space (DIFS), point coordination inter frame space (PIFS), and short inter frame space (SIFS).

In example embodiments of the disclosure, there may be a wireless communication apparatus. The apparatus may include a means for determining, by a first computing device comprising one or more processors and at least one radio component, a transmission status of a first wireless channel allocated for sending of one or more data packets from the first computing device to a second computing device. The apparatus may include a means for detecting, by the first computing device, a second wireless channel. The apparatus may include a means for detecting, by the first computing device, a workload level of the second wireless channel associated with an interference with the first wireless channel. The apparatus may include a means for sending, by the first computing device, a wake-up data packet to the second computing device based at least in part on the workload level. The apparatus may further include a means for determining, by the first computing device, an idle status of the second wireless channel. The interference may alter the wake-up packet into a distorted wake-up packet. Sending the wake-up data packet may be based at least in part on the idle status of the second wireless channel. The apparatus may further include a means for receiving, by the first computing device, a clear to send message from the second computing device in response to sending the wake-up packet. The workload level may be an energy level associated with one or more data transmissions on the second channel. A means for determining the transmission status may include a means for determining if the first wireless channel is idle. The second wireless channel may be adjacent to the first wireless channel. A means for detecting the workload level may further include a means for detecting a first workload that satisfies an interference threshold, and a means for detecting, after a delay of at least a channel access delay duration a second workload level that does not satisfy the interference threshold. The channel access delay duration may include at least one of distributed coordination inter frame space (DIFS), point coordination inter frame space (PIFS), and short inter frame space (SIFS).

### CONCLUSION

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method of wireless communication comprising:
determining, by a first computing device comprising one or more processors and at least one radio component, a transmission status of a first wireless channel allocated for sending of one or more data packets from the first computing device to a second computing device;
detecting, by the first computing device, a second wireless channel;
detecting, by the first computing device, a workload level of the second wireless channel associated with an interference with the first wireless channel; and
sending, by the first computing device, a wake-up data packet to the second computing device based at least in part on the workload level.

2. The method of claim 1, wherein the workload level is an energy level associated with one or more data transmissions on the second channel.

3. The method of claim 1, wherein the second wireless channel is adjacent to the first wireless channel.

4. The method of claim 1, wherein the interference alters the wake-up packet into a distorted wake-up packet.

5. The method of claim 1, wherein sending the wake-up data packet is based at least in part on an idle status of the second wireless channel.

6. The method of claim 1, further includes receiving, by the first computing device, a clear to send message from the second computing device in response to sending the wake-up packet.

7. The method of claim 1, wherein determining the transmission status includes determining if the first wireless channel is idle.

8. The method of claim 1, wherein detecting the workload level further comprises:
detecting a first workload that satisfies an interference threshold; and
detecting, after a delay of at least a channel access delay duration, a second workload level that does not satisfy the interference threshold.

9. The method of claim 8, wherein the channel access delay duration includes at least one of distributed coordination inter frame space (DIFS), point coordination inter frame space (PIFS), and short inter frame space (SIFS).

10. A computing device, comprising:
a transceiver configured to transmit and receive wireless signals;
an antenna coupled to the transceiver;
one or more processors in communication with the transceiver;
at least one memory that stores computer-executable instructions; and
at least one processor of the one or more processors configured to access the at least one memory, wherein the at least one processor is configured to execute the computer-executable instructions to:
determine a transmission status of a first wireless channel allocated for sending of one or more data packets from the first computing device to a second computing device;
detect a second wireless channel;
detect a workload level of the second wireless channel associated with an interference with the first wireless channel; and
send a wake-up data packet to the second computing device based at least in part on the workload level.

11. The computing device of claim 10, wherein the workload level is an energy level associated with one or more data transmissions on the second channel.

12. The computing device of claim 10, wherein the interference alters the wake-up packet into a distorted wake-up packet.

13. The computing device of claim 10, wherein sending the wake-up data packet is based at least in part on an idle status of the second wireless channel.

14. The computing device of claim 10, further includes receiving, by the first computing device, a clear to send message from the second computing device in response to sending the wake-up packet.

15. The computing device of claim 10, wherein determining the transmission status includes determining if the first wireless channel is idle.

16. The computing device of claim 10, wherein detecting the workload level further comprises:
detecting a first workload that satisfies an interference threshold; and
detecting, after a delay of at least a channel access delay duration, a second workload level that does not satisfy the interference threshold

17. A non-transitory computer-readable medium storing computer-executable instructions which, when executed by a processor, cause the processor to perform operations comprising:
determining a transmission status of a first wireless channel allocated for sending of one or more data packets from the first computing device to a second computing device;
detecting a second wireless channel;
detect a workload level of the second wireless channel associated with an interference with the first wireless channel; and
sending a wake-up data packet to the second computing device based at least in part on the workload level.

18. The non-transitory computer-readable medium of claim 17, wherein the interference alters the wake-up packet into a distorted wake-up packet.

19. The non-transitory computer-readable medium of claim 17, wherein sending the wake-up data packet is based at least in part on an idle status of the second wireless channel.

20. The non-transitory computer-readable medium of claim 17, wherein detecting the workload level further comprises:
detecting a first workload that satisfies an interference threshold; and
detecting, after a delay of at least a channel access delay duration, a second workload level that does not satisfy the interference threshold.

21. The non-transitory computer-readable medium of claim 20, wherein the channel access delay duration includes at least one of distributed coordination inter frame space (DIFS), point coordination inter frame space (PIFS), and short inter frame space (SIFS).
